(19) United States
(12) Patent Application Publication
(10) Pub. No.: US 2019/0257794 A1
(43) Pub. Date: Aug. 22, 2019

(54) REAL-TIME DAMAGE DETECTION AND LOCALIZATION OF DAMAGE IN VEHICLE COMPONENTS USING ACOUSTIC EMISSION AND MACHINE LEARNING

(71) Applicant: GM GLOBAL TECHNOLOGY OPERATIONS LLC, Detroit, MI (US)

(72) Inventors: Megan E. McGovern, Royal Oak, MI (US); Selina X. Zhao, Rochester Hills, MI (US); Anthony L. Smith, Troy, MI (US); Shailendra Kaushik, Novi, MI (US); Jinglin Li, Troy, MI (US); Jessica A. Dibra, Royal Oak, MI (US); Diana M. Wegner, Bloomfield Hills, MI (US)

(21) Appl. No.: 15/900,938

(22) Filed: Feb. 21, 2018

(51) Int. Cl. G01N 29/14; G06N 99/00; G07C 5/08; G01N 29/04; G01N 29/24

(52) U.S. Cl. CPC G01N 29/14; G06N 99/005; G07C 2205/02; G01N 29/043; G01N 29/2475; G07C 5/0808

(57) ABSTRACT

A method for damage detection and location using acoustic emission includes receiving, via a processor, an acoustic feedback signal from a plurality of sensors embedded in a body panel of a vehicle. The processor identifies a body panel breach and a location of the body panel breach indicative of damage on the body panel. The processor identifies the body panel breach based on the acoustic feedback signal from the plurality of sensors.

### INTRODUCTION

The subject disclosure relates to vehicle body panel damage detection, and more specifically to computer-driven detection of damage in a vehicle body panel using acoustic signatures and machine learning.

Vehicles in road service often encounter environmental factors that can damage body panels or other vehicle components. For example, highway driving can kick up stones or other objects that can strike and damage a non-metallic body panel made from carbon fiber, polytetrafluoroethylene (PTFE), or another material. Other environmental factors such as road surface, vehicle panel material, and time can also weigh on the development of vehicle panel damage. Some defects may not be visible, but may still be substantial.

All materials emit an acoustic emission created by subtle vibrations from environmental factors. For example, the engine vibration in a combustion engine can also vibrate body panels at various frequencies matching engine operation. Travel across uneven surfaces, tire noise, etc. can also cause the rest of the vehicle to emit acoustic emission at extremely low amplitudes. The acoustic emission of various portions of the automobile may be characterized by their unique acoustic signature, which changes with body panel material, body panel shape, defect size, type, location, and other factors.

With sensors and other listening devices, acoustic emission by the vibrating automotive materials may be used to detect, locate, and classify damage causing events in the vehicle, and evaluate the damage caused by these events. For example, acoustic emission of the body panels in a vehicle can be processed to identify unseen or visible defects in the body panels of vehicles. However, damage identification using acoustic emission often fails in noisy environments, preventing its use as a real-time damage monitoring technique using conventional technologies. Vehicles in operation have their own acoustic signatures, which add to background noises.

Accordingly, it is desirable to provide a system for vehicle monitoring using acoustic emission sensors and a controller that isolates and removes background noise from the acoustic signal. It is also desirable to provide a vehicle structure monitoring system that incorporates knowledge of where damage can most likely occur given a particular set of operational and environmental factors, identifies and monitors acoustic anomalies that could be indicative of vehicle damage, and tracks any faults in the vehicle structure that develop and increase over time.

### SUMMARY

In one exemplary embodiment a method for damage detection and location using acoustic emission includes receiving, via a processor, an acoustic feedback signal from a plurality of sensors embedded in a body panel of a vehicle. The processor identifies a body panel breach and a location of the body panel breach indicative of damage on the body panel. The processor identifies the body panel breach based on the acoustic feedback signal from the plurality of sensors.

In another exemplary embodiment, a system for detecting and locating a body panel breach on a vehicle includes a processor operatively connected with a plurality of embedded sensors in the body panel of the vehicle. The processor is configured to receive acoustic feedback signal from the plurality of sensors and identify a panel breach and a location of the panel breach indicative of damage on the body panel. The processor identifies the panel breach and the location of the panel breach based on the acoustic feedback signal from the plurality of sensors.

In another exemplary embodiment, a computer-readable storage medium storing executable instructions is configured to, when executed by a processor, cause the processor to perform a method. The method includes receiving, via a processor, an acoustic feedback signal from a plurality of sensors embedded in a body panel of a vehicle. The processor identifies a body panel breach and a location of the body panel breach indicative of damage on the body panel. The processor identifies the body panel breach based on the acoustic feedback signal from the plurality of sensors.

In addition to one or more of the features described herein, identifying the body panel breach includes isolating, via the processor, an acoustic signature from the acoustic feedback signal. The processor compares the acoustic signature to a plurality of acoustic signatures stored on an acoustic signature database, and identifies a matching signature wherein the matching signature shares a predetermined number of identifying components with the acoustic signature.

In another embodiment, the processor determines a location on the body panel having the body panel breach, where the panel breach alters the acoustic signature of the body panel.

In another embodiment, identifying the body panel breach and the location of the body panel breach includes identifying an acoustic signature anomaly in the acoustic feedback signal, and determining whether the acoustic signature anomaly is dispositive of the body panel breach. Responsive to determining that the acoustic signature anomaly is not dispositive of the body panel breach, the processor compares the acoustic signature anomaly to one or more stored acoustic signature anomalies during a predetermined period of time. The processor then detects a change in the acoustic signature anomaly that is indicative of the body panel breach.

In yet another embodiment, detecting the change in the acoustic signature anomaly includes determining a propagation of the body panel breach after the predetermined period of time, where the propagation of the body panel breach is indicative of an increase in a dimension of the breach with respect to time, and indicative of a location of the increase in dimension of the body panel breach.

In another embodiment, the processor stores an identification record indicative of a body panel material, a body panel geometry, and an environmental exposure characteristic of the body panel. The processor then compares the panel material, the panel geometry, and the environmental exposure characteristic to a plurality of identification records. The processor then identifies, based on the comparison, a sensor position change of the sensor on the body panel. Identifying the sensor position change includes identifying whether the sensor position change has resulted in an acoustic signature match rate that is greater than the acoustic signature match rate associated with the body panel. The location of one or more sensors of the plurality of sensors on the body panel is then changed based on the identification record, where the changed location matches a sensor position of the body panel having the greater acoustic signature match.

In another embodiment, the processor outputs an output signal indicative of the panel breach and the location of the body panel breach, where the processor sends the output signal to at least one of a mobile device and a vehicle output interface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a damage detection and localization system for a vehicle, according to one embodiment;

FIG. 2 depicts a graph used to identify a location of a body panel breach according to an embodiment;

FIG. 3 is a system for isolating and identifying an acoustic signature according to an embodiment; and

FIG. 4 is a computing system for implementing embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

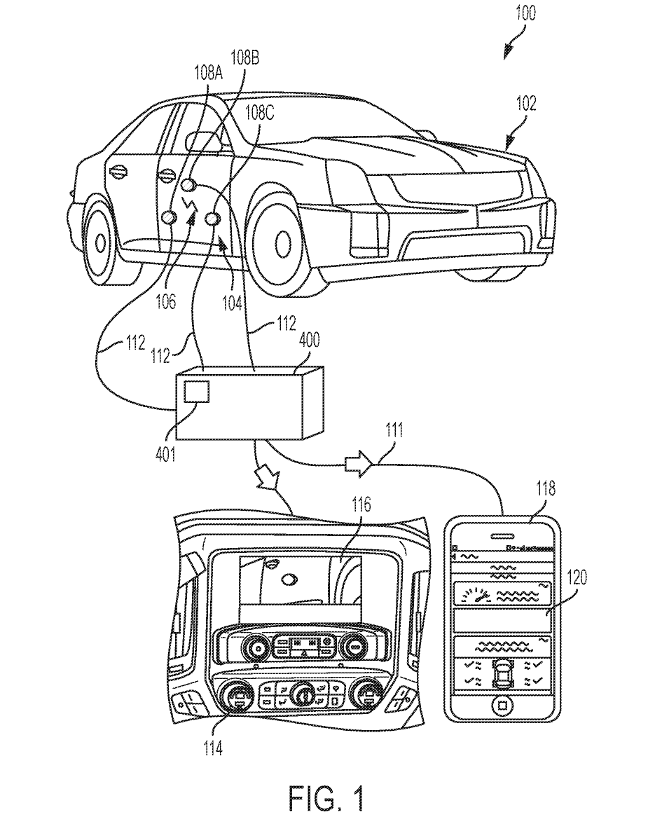

In accordance with an exemplary embodiment, FIG. 1 depicts a damage detection and localization system 100 for vehicle 102. The system 100 includes a plurality of sensors 108 embedded in a body panel 104 of the vehicle 102. The plurality of sensors 108 are operatively connected with a computing system 400 via a sensor bus 112. The computing system 400 includes a processor 401 that is configured to send a signal to a plurality of sensors 108, receive a signal response from the plurality of sensors 108, interpret the signal response, and output an alert indicative of body panel damage to one or more of a vehicle output interface 114 configured inside of the vehicle 102, and/or a mobile device 118 operatively connected with the system 100.

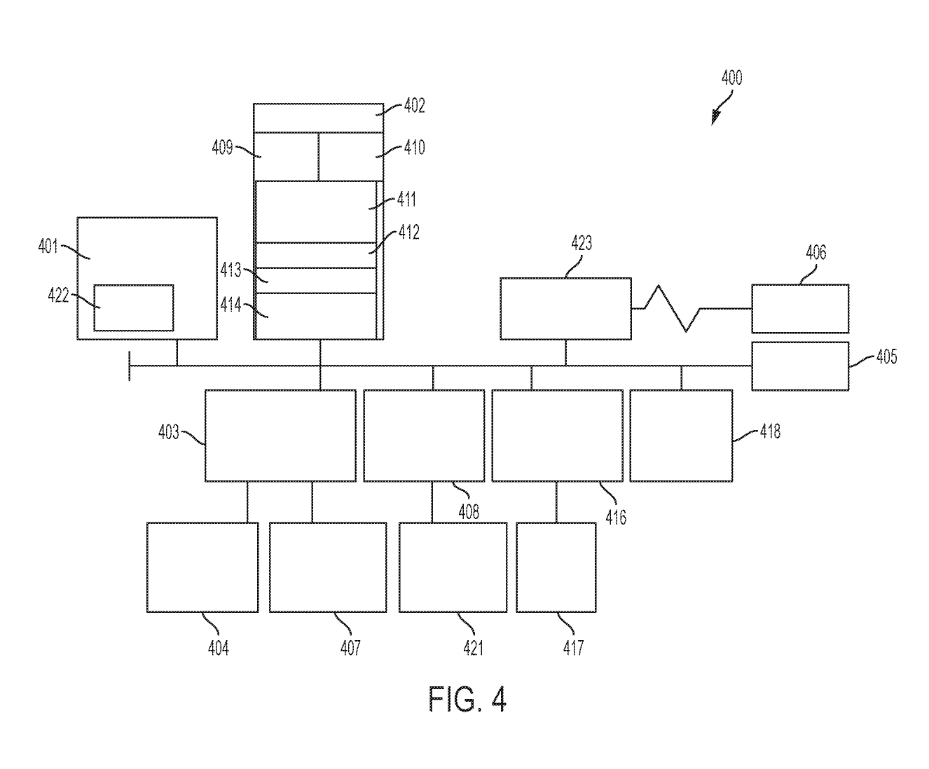

The computing system 400, described in greater detail with respect to FIG. 4, may connect with the vehicle 102 via wired or wireless communication channels 111. It should also be appreciated that the sensors 108 may connect with one another as a network array, or individually connect to the computing system 400. The sensor bus 112 may be a wired or wireless communication bus.

In some aspects, system 100 can be configured to detect and diagnose structural damage to the vehicle in real-time (e.g., while the vehicle is in use on the road) by listening for acoustic properties emitted by the vehicle components. For example, as shown in FIG. 1, the vehicle 102 includes a body panel 104 (shown as part of the door of the vehicle 102 as an example). The body panel 104 is embedded with the plurality of sensors 108, which are shown as a triangular array. Although only three sensors 108 are depicted in FIG. 1, it should be appreciated that any number of sensors are contemplated, where at least three are used to locate the presence and location of a body panel fault (e.g., a crack, breach, etc.) using acoustic emission from the panel. Other configurations are possible based on vehicle panel geometry, materials, types of uses for the vehicle 102, environmental conditions, etc. Moreover, although shown as an array on the body panel 104, it should be appreciated that the system 100 can be configured on any vehicle surface subject to potential damage while in use. For example, a body panel on the vehicle 102, a structural component such as a frame member, or another vehicle 102 portion is contemplated.

The sensors 108 can be, collectively, a Piezo-electric film adhered to or otherwise embedded in one or more body panels 104 of the vehicle 102. Piezo-electric films are known in the art, and can include a plurality of Piezo sensors that transmit signals based on sound pressure, vibrational energy, etc. Although described as a Piezo-electric sensor, any of the sensors 108 can be any type of sensor suitable for obtaining acoustic emission signals and transmitting the obtained signals to a processor (e.g., the processor 401).

According to one embodiment, the computing system 400 is constantly listening to the acoustic response of the vehicle member having the sensors 108. It is known in the art to determine a location of an anomaly (e.g., a body panel breach 106) using three or more sensors listening for the sounds emitted by the observed object. Acoustic emission can be used to determine whether there is damage to the body panel 104. As the body panel 104 vibrates while in use (the vibration caused by engine vibration, road vibrations, environmental sound waves, environmental factors such as wind, rain, etc.) the vibratory sounds or emission can change between its undamaged state (having no breach 106) and damaged state (having the breach 106). By observing and processing the change in vibratory sounds observed by the processor, the damage may be identified, categorized, and located by the processor 401.

In some aspects, the processor 401 is configured to listen for the acoustic emission of the body panel 104 by receiving an acoustic feedback signal from the plurality of sensors 108 embedded in the body panel 104. The processor 401 identifies the body panel breach 106 and the location of the body panel breach 106 by comparing the acoustic feedback signal before the anomaly and after the anomaly. In one aspect, the processor 401 removes the background noise from the acoustic signal, and isolates the acoustic signature of the specific anomaly. Using the processor 401, the system 100 also determines a precise location of a body panel breach or anomaly indicative of a possible breach. After identifying the existence and location of the damage to the body panel 104, the processor 401 sends an output signal to one or more of vehicle output interface 114 in the cab of the vehicle 102, or one or more of an operatively connected mobile device, such as the mobile device 118 shown in FIG. 1. The mobile device 118 and/or the vehicle output interface can issue a damage warning on the mobile device display 120 that alerts an operator of the panel breach and the location of the body panel breach. In other aspects, the processor may include size of damage information indicative of a dimensional size of the damage or breach in the body panel 104.

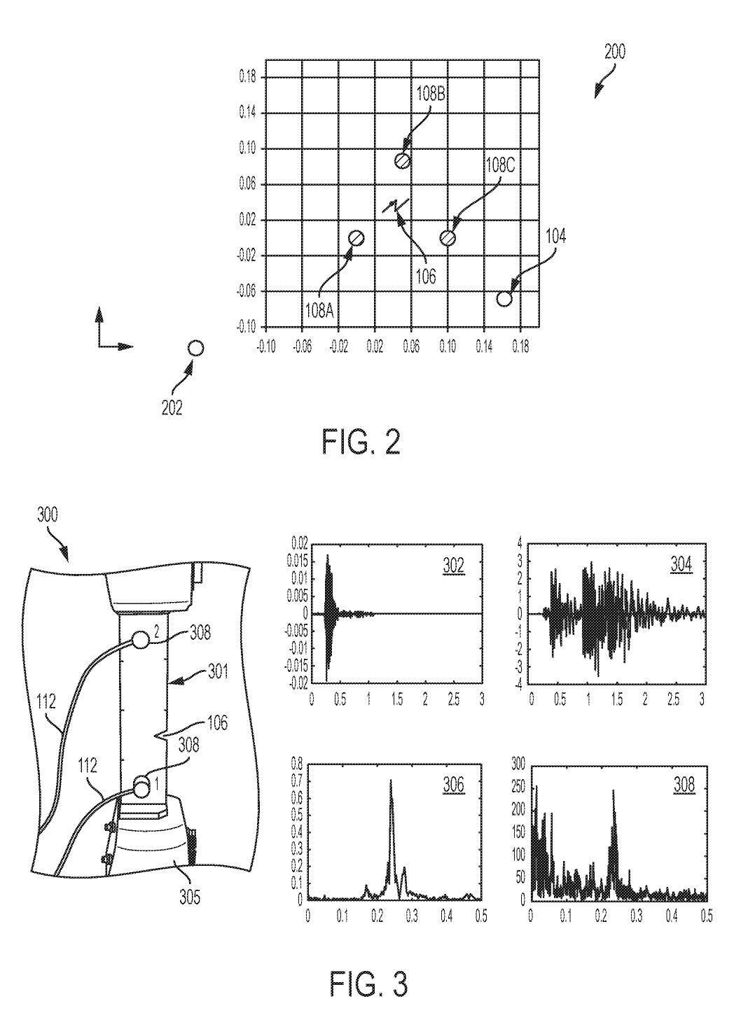

FIG. 2 depicts an exemplary graph 200 of a technique for source location of a breach in a body panel 104, according to one embodiment. The precise location of the breach 106 may be identified by the processor 401 in absolute terms respective to a locating datum point 202. The datum point 202 may be arbitrarily chosen anywhere on the vehicle 102. In some aspects, the locating datum point 202 is located proximate to a surface of the body panel 104 that the sensors 108 are listening/monitoring. For example, as shown in FIG. 2, the relative location of the body panel breach 106 is identifiable with respect to the locating datum point 202 by identifying the point in the x and y planes of the body panel 104 at which the breach starts and stops.

The acoustic signature of the body panel 104 can indicate details about the presence of damage to the body panel. In some aspects, the location of the breach is precisely locatable by listening for acoustic signatures emitted by the body panel 104 with respect to each of at least three sensors 108A, 108B, and 108C. It is known in the art to locate a precise location of a sound or vibration-emitting source by measuring the distance of the acoustic emission with respect to time, frequency content, wave-mode of the signal (e.g., shear, dilatational, etc.), energy of the signal, power spectral density (PSD) of the signal, ratio of high frequency amplitude to low frequency amplitude, signal attenuation, and other properties of sound as it is perceived by a plurality of sensors. Although referred to collectively as an acoustic signature, it should be appreciated that any one or more of the foregoing properties of sound measurement can uniquely identify (or provide a probability of positively identifying) a known combination of body panel materials, defects in those materials, and location of an identified defect. As used herein, acoustic signature refers to measured properties of the sound emission sampled by the plurality of sensors 108. The properties measured can also include count, magnitude of the signal, duration of the signal, and other properties.

Passive acoustic location involves the detection of sound or vibration created by the object being detected, which is then analyzed to determine a probable location of the object (or in the present case, defect) at issue. For example, seismic surveys involve the generation of sound waves to measure underground structures. With this technique, source waves are created by percussion mechanisms located near the ground or water surface, typically dropped weights, vibroseis trucks, or explosives. Data are collected with geophones, then stored and processed by a processor. Using the example of passive acoustic location in earthquake location, precise points of origination are discernable by listening for various acoustic properties known and catalogued that indicate various factors associated with the signal being perceived by the listening device. The acoustic location of earthquakes is derivable based on a body of known information of the properties of sound vibration as they propagate through solid bodies and air. The properties used in earthquake identification were learned over time.

It may be advantageous to learn about the acoustic properties of various vehicle materials in a compressed time frame using machine learning. For example, identifying a precise location of the body panel breach 106 may be learned with conventional techniques given a particular (known) body panel geometry, a particular excitation (e.g., a known source vibration having a known frequency response), and a known frequency response for the specific damage in the body panel. However, when any one or more of these factors change or are unknown, using conventional techniques as described above it is difficult if not impossible to precisely determine the existence and location of the body panel breach 106. An added difficulty of real-time identification of acoustic emissions is environmental noise that makes the acoustic signals unusable outside of a laboratory environment.

According to embodiments of the present disclosure, this limitation is resolved by using machine learning to mitigate the effects of background noise and characterize acoustic signatures of vehicles using the system 100. For example, machine learning algorithms are configured to catalogue acoustic features for frequency content, time-of-flight, wave-mode, energy, power spectral density, ratio of high to low frequencies, attenuation of sounds, etc. In one aspect, the processor 401 can then isolate an acoustic signature from the acoustic feedback signal received from the plurality of sensors 108, compare the acoustic signature to a plurality of acoustic signatures stored on an acoustic signature database (e.g., one or more databases 421 as shown with respect to FIG. 4), and identify a matching signature. The various known ways for characterizing and categorizing sound properties (e.g., the acoustic features described above) are compared by the processor 401 with the known and catalogued acoustic signatures in the database 421. Each of the components that match between the acoustic signature of the body panel 104 (having the breach 106) are compared and matched to properties that are known of other acoustic signatures. In one aspect, the processor 401 can identify a type of breach (e.g., a crack, a stress fracture, a hole, a dent, etc.) based on detection of a matching signature. A matching signature shares a predetermined number of identifying components with the acoustic signature (e.g., some n number of predetermined properties that would indicate a match).

FIG. 3 depicts a testing system 300 for isolating and identifying an acoustic signature according to an embodiment. To overcome the problem of separating background noises from the subtle acoustic signatures that can identify a type of damage and a location for that damage, the processor 401 is configured with an acoustic signature engine (e.g., the engine 414 shown with respect to FIG. 4). The testing system 300 is configured to train the acoustic engine 414 to associate various acoustic signatures with types of damage on various materials. The acoustic engine 414 uses the associations to separate the background noises from the useful portions of acoustic emissions.

Training the system 100 takes place, in part, in a controlled laboratory environment, and in part in the field as the vehicle 102 experiences different types of real-world environmental conditions that may cause damage to the body panels 104. In the controlled laboratory environment, the four-post test is known in the art as a testing configuration for vehicles to produce a variety of conditions that the vehicle could encounter when in road service. In the present case, the four-post testing can characterize the effect of environmental noise under different conditions to obtain, identify, and categorize acoustic signatures associated with a particular vehicle. Vehicles of the same make, model, and year will include similar materials that, in conjunction with one another, emit an acoustic signature that changes based on environmental conditions such as road type, smoothness, weather conditions, temperature, etc. By training the system 100, the acoustic signature of the vehicle 102 can be identified for its removal as background noise from any obtained sensor data.

The first stage controlled laboratory training of the system 100 includes 1) training the set, 2) validation of the training set, and 3) testing the validated set. In one aspect, to train the system, the processor 401 can instantiate the engine 414 in conjunction with the database 421. The database 421 stores acoustic signatures associated with a variety of materials and types of body panel damage that are used by the processor 401 to identify, classify, and locate the breach 106. As shown in FIG. 3, the testing system 300 can include a sensor 308 is the same type of sensor as the sensors 108 that are configured as a sensor array on the vehicle 102. The sensor 308 is configured to (by adhering or embedding the sensors on a test piece 301) to test a particular material (e.g., polytetrafluoroethylene (PTFE)) for the acoustic signatures associated with that material, and to observe and record and catalogue the acoustic signatures associated particular types of physical damage on that material. For example, a PTFE body panel having a crack has a different acoustic signature than a carbon fiber body panel with the same type of crack. Induction of the controlled damage in an otherwise quiet laboratory environment provides a training set that can develop subsequent models to classify damage. Using machine learning algorithms known in the art, the training set is observable by the processor 401 as it is applied to new environmental situations in the field.

A second phase of training the system 100 includes training the set in a controlled laboratory environment, but with the introduction of a controlled background noise during the four-post test. For example, using the known acoustic signature of a particular material can be observed and catalogued in the presence of the introduced background noise.

In a third phase for training the system 100, controlled damage is introduced during the introduction of the controlled background noise (e.g., during a limited on-road test). The database 421 is updated with associations between various types of background noises (so that they may be ignored or removed from signals retrieved in the field) and the acoustic signatures of the various types of damage to materials used in the body panels 104. While specific geometries of the same materials may have similar acoustic signatures when tested under the same conditions, when the damage type (i.e., the breach described herein) changes, the acoustic signature of that material being tested may also change. For example, a frequency response in the time domain 304 is shown for the particular test piece in the fixture 305 holding the test piece 301. As the processor 401 perceives background noise 302 in the laboratory or the field (i.e., when the vehicle is in use), the processor 401 uses the previously-learned acoustic emission signatures stored in the database 421 to isolate the useful portions of the overall background noise 302 from the acoustic emission indicative of specific damage. Stated in another way, the processor 401 knows which acoustic signatures to listen for because the system has encountered them before and can recognize the acoustic signal portions even amongst a symphony of accompanying background noise. By identifying, monitoring, and noting the changes in identified acoustic signal portions, the system 100 can indicate the presence of, nature of, and size of the body panel breach 106.

In other aspects, a machine learning engine is stored on the memory 402, and configured to listen for damage during on-road tests to understand differences between controlled environment acoustic signatures and acoustic signatures on the road. During the road-testing phase, the database 421 is updated by the processor 401 to include various acoustic signatures with observed conditions of body panels 104. Stated in another way, various types of breaches are introduced, tested, and associated with the resulting acoustic signatures emitted from the body panel 104.

In another aspect, the acoustic signature of the body panel 104 in a whole (unbreached) condition and a breached condition may be known. However, an anomaly can occur that is not identifiable as either the breached acoustic signature or the unbreached acoustic signature. In one aspect, the processor 401 may identify the acoustic signature anomaly in the acoustic feedback signal, determine whether the acoustic signature anomaly is dispositive of the body panel breach, and if it is not dispositive, compare the acoustic signature anomaly during a predetermined period of time to monitor any changes in the acoustic signature(s) at issue. Over time, a change in the acoustic signature after observation of an anomaly may be indicative of a body panel breach. For example, known statistical analyses are applied to acoustic emission signals over a period of time (e.g., periodically sampled at n times per minute/hour/day, etc., for a period of a day, a week, a month, etc.) to detect and evaluate changes in the acoustic signature indicative of damage. When the processor 401 determines that a breach has a probability of being present, the processor 401 may trigger an alarm (e.g., output a message to one or more of the display 116 in the vehicle 102 or the mobile device display 120).

An anomaly as used herein refers to an acoustic signature that is different from prior acoustic signatures recorded under similar circumstances. The anomaly refers to the presence of the observed difference in signals. As used herein, a probability of being present means that the probability that an observed anomaly being actual damage to the body panel 104 meets or exceeds a predetermined threshold for a positive identification. For example, a 65% match may be considered a probable match, while a 35% match is inconclusive, and a 5% match is a dispositive result indicating that the observed anomaly is not a body panel breach.

The processor 401 stores an identification record in the database 421. The identification record indicates details about the circumstances associated with a particular acoustic signature such as, for example, the body panel material, the body panel geometry (e.g., the shape), and environmental exposure characteristic of the body panel (e.g., temperature of the environment, moisture, presence of road salts, vibrations, etc.). In some aspects, the processor 401 compares the panel material, the panel geometry, and the one or more environmental exposure characteristics to a plurality of identification records in the database 421. A match rate is indicative of how often a match is made between a particular acoustic feature and a particular type of damage. A match is made when a predetermined portion of the listened-for acoustic feature is within a bracket of known values. For example, a carbon fiber body panel may emit a particular frequency content having relatively higher amplitudes (e.g., of content at frequencies 0.02 MHz and 0.025 MHz). When the processor 401 identifies an acoustic emission having an amplitude that falls within a bracket of expected amplitude (e.g., between 0.6 and 0.7 millivolts) at the 0.02 MHz and the 0.025 MHz frequencies, the processor 401 may register a match. Identification of a match indicates that an acoustic emission has been positively identified given a particular sensor configuration.

The processor 401 then identifies whether the sensor positioning can be optimized given a particular set of circumstances. The acoustic path associated with sensor positioning optimization may be a pre-process step that can be embedded into the processor. In some aspects, the sensor positioning optimization is not a real-time process that can be combined with the machine learning process to provide optimized sensor position based on the body panel stress concentration area. To do this, the processor 401 compares like circumstances, materials and body panel geometry to known identification records, and identifies sensor configurations producing better resolved signals (e.g., higher signal to noise ratios, damage detectability, ability to localize damage, etc.) than the signal associated with the configuration at issue. This should be done for a wide array of sensor placements and damage locations, and it will be different based upon the material and geometry of the component.

Accordingly, the processor 401 may suggest, based on the comparison, a sensor position change of the sensor on the body panel, where the sensor position change is likely to result in an acoustic signal that is more resolved (e.g., higher signal to noise ratio) than the presently-observed acoustic signals associated with the body panel. For example, the processor 401 may output a message to the vehicle output interface 114 or the mobile device display 120 indicative that an optimization is identified, and output an optimized position for one or more sensors of the plurality of sensors 108 on the body panel 104. The changed location matches a known sensor position of the body panel having the greater acoustic signature match. Alternatively, machine learning can be used to optimize sensor placement determining the best location based on the acoustic signature match rate.

FIG. 4 illustrates a block diagram of an exemplary computing environment and computer system 400 for use in practicing the embodiments described herein. The environment and system described herein can be implemented in hardware, software (e.g., firmware), or a combination thereof. In an exemplary embodiment, a hardware implementation can include a microprocessor of a special or general-purpose digital computer, such as a personal computer, workstation, minicomputer, or mainframe computer. Computer 400 therefore can embody a general-purpose computer. In another exemplary embodiment, the implementation can be part of a mobile device, such as, for example, a mobile phone, a personal data assistant (PDA), a tablet computer, etc.

As shown in FIG. 4, the computer 400 includes processor 401. Computer 400 also includes memory 402 communicatively coupled to processor 401, and one or more input/output adapters 403 that can be communicatively coupled via system bus 405. Memory 402 can be communicatively coupled to one or more internal or external memory devices, such as a database 421, via a storage interface 408. A mobile communications adapter 423 can communicatively connect computer 400 to one or more networks 406. An input/output (I/O) adapter 403 can connect a plurality of input devices 404 to computer 400. Input devices can include, for example, a keyboard, a mouse, a microphone, a sensor, etc. System bus 405 can also communicatively connect one or more output devices 407 via I/O adapter 403. Output device 407 can include, for example, a display, a speaker, a touchscreen, etc.

Processor 401 is a hardware device for executing program instructions (aka software), stored in a computer-readable memory (e.g., memory 402). Processor 401 can be any custom made or commercially available processor, a central processing unit (CPU), a plurality of CPUs, an auxiliary processor among several other processors associated with the computer 400, a semiconductor based microprocessor (in the form of a microchip or chip set), or generally any device for executing instructions. Processor 401 can include a cache memory 422, which can include, but is not limited to, an instruction cache to speed up executable instruction fetch, a data cache to speed up data fetch and store, and a translation lookaside buffer (TLB) used to speed up virtual-to-physical address translation for both executable instructions and data. Cache memory 422 can be organized as a hierarchy of more cache levels (L1, L2, etc.).

Processor 401 can be disposed in communication with one or more memory devices (e.g., RAM 410, ROM 409, one or more external databases 421, etc.) via a storage interface 408. Storage interface 408 can also connect to one or more memory devices including, without limitation, one or more databases 421, and/or one or more other memory drives (not shown) including, for example, a removable disc drive, etc., employing connection protocols such as serial advanced technology attachment (SATA), integrated drive electronics (IDE), IEEE-1394, universal serial bus (USB), fiber channel, small computer systems interface (SCSI), etc. The memory drives can be, for example, a drum, a magnetic disc drive, a magneto-optical drive, an optical drive, a redundant array of independent discs (RAID), a solid-state memory device, a solid-state drive, etc.

Memory 402 can include random access memory (RAM) 410 and read only memory (ROM) 409. RAM 410 can be any one or combination of volatile memory elements (e.g., DRAM, SRAM, SDRAM, etc.). ROM 409 can include any one or more nonvolatile memory elements (e.g., erasable programmable read only memory (EPROM), flash memory, electronically erasable programmable read only memory (EEPROM), programmable read only memory (PROM), tape, compact disc read only memory (CD-ROM), disk, cartridge, cassette or the like, etc.). Moreover, memory 402 can incorporate electronic, magnetic, optical, and/or other types of non-transitory computer-readable storage media. Memory 402 can also be a distributed architecture, where various components are situated remote from one another, but can be accessed by processor 401.

The instructions in memory 402 can include one or more separate programs, each of which can include an ordered listing of computer-executable instructions for implementing logical functions. In the example of FIG. 4, the instructions in memory 402 can include an operating system 411. The operating system 411 can control the execution of other computer programs and provides scheduling, input-output control, file and data management, memory management, and communication control and related services.

The program instructions stored in memory 402 can further include application data 412, and instructions for a user interface 413.

Memory 402 can also include program instructions for an acoustic signature engine 414, configured to associate various acoustic signatures with types of damage on various materials, and separate the background noises from the useful portions of acoustic emissions. The acoustic signature engine 414 can be configured as (or configured with) machine learning algorithms known in the art to improve the database 421, and improve placement of the sensors 108.

I/O adapter 403 can be, for example but not limited to, one or more buses or other wired or wireless connections. I/O adapter 403 can have additional elements (which are omitted for simplicity) such as controllers, microprocessors, buffers (caches), drivers, repeaters, and receivers, which can work in concert to enable communications. Further, I/O adapter 403 can facilitate address, control, and/or data connections to enable appropriate communications among the aforementioned components.

I/O adapter 403 can further include a display adapter coupled to one or more displays. I/O adapter 403 can be configured to operatively connect one or more input/output (I/O) devices to computer 400. For example, I/O adapter 403 can connect a keyboard and mouse, a touchscreen, a speaker, a haptic output device, or other output device. Output devices 407 can include but are not limited to a printer, a scanner, and/or the like. Other output devices can also be included, although not shown. A graphics processing unit 418 may also be included that functions to process graphics for graphic output on the output devices 407. Finally, the I/O devices connectable to I/O adapter 403 can further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like.

According to some embodiments, computer 400 can include a mobile communications adapter 423. Mobile communications adapter 423 can include GPS, cellular, mobile, and/or other communications protocols for wireless communication.

Network 406 can be an IP-based network for communication between computer 400 and any external device. Network 406 transmits and receives data between computer 400 and devices and/or systems external to computer 400. In an exemplary embodiment, network 406 can be a managed IP network administered by a service provider. Network 406 can be implemented in a wireless fashion, e.g., using wireless protocols and technologies, such as WiFi, WiMax, etc. Network 406 can also be a wired network, e.g., an Ethernet network, a controller area network (CAN), etc., having any wired connectivity including, e.g., an RS232 connection, R5422 connection, etc. Network 406 can also be a packet-switched network such as a local area network, wide area network, metropolitan area network, Internet network, or other similar type of network environment. The network 406 can be a fixed wireless network, a wireless local area network (LAN), a wireless wide area network (WAN) a personal area network (PAN), a virtual private network (VPN), intranet or other suitable network system.

The memory 402 can further include a basic input output system (BIOS) (omitted for simplicity). The BIOS is a set of routines that initialize and test hardware at startup, start operating system 411, and support the transfer of data among the operatively connected hardware devices. The BIOS is typically stored in ROM 409 so that the BIOS can be executed when computer 400 is activated. When computer 400 is in operation, processor 401 can be configured to execute instructions stored within the memory 402, to communicate data to and from the memory 402, and to generally control operations of the computer 400 pursuant to the instructions.

The embodiments described in the present disclosure can be a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing/processing device.

Computer readable program instructions for carrying out operations of embodiments of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language and procedural programming languages. The computer readable program instructions can execute entirely on the computing platform (e.g., computing system 400), partly on the computing system 400, as a stand-alone software package, partly on a user's computer and partly on a remote computer or entirely on the remote computer or server. In the latter scenario, the remote computer can be connected to the user's computer through any type of network (e.g., the network 406), including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for damage detection and location using acoustic emission comprising:
receiving, via a processor, an acoustic feedback signal from a plurality of sensors embedded in a body panel of a vehicle; and
identifying, via the processor, a body panel breach and a location of the body panel breach indicative of damage on the body panel, the identifying based on the acoustic feedback signal from the plurality of sensors.

2. The method of claim 1, wherein identifying the body panel breach comprises:
isolating, via the processor, an acoustic signature from the acoustic feedback signal;
comparing, via the processor, the acoustic signature to a plurality of acoustic signatures stored on an acoustic signature database; and
identifying, via the processor, a matching signature wherein the matching signature shares a predetermined number of identifying components with the acoustic signature.

3. The method of claim 2, further comprising:
determining, via the processor, a location on the body panel having the body panel breach, wherein the panel breach alters the acoustic signature of the body panel.

4. The method of claim 1, wherein identifying the body panel breach and the location of the body panel breach comprises:
identifying an acoustic signature anomaly in the acoustic feedback signal;
determining whether the acoustic signature anomaly is dispositive of the body panel breach;
responsive to determining that the acoustic signature anomaly is not dispositive of the body panel breach, comparing the acoustic signature anomaly to one or more stored acoustic signature anomalies during a predetermined period of time; and
detecting, via the processor, a change in the acoustic signature anomaly that is indicative of the body panel breach.

5. The method of claim 4, wherein detecting the change in the acoustic signature anomaly comprises determining a propagation of the body panel breach after the predetermined period of time, wherein the propagation of the body panel breach is indicative of an increase in a dimension of the breach with respect to time, and indicative of a location of the increase in dimension of the body panel breach.

6. The method of claim 1, further comprising:
storing an identification record indicative of a body panel material, a body panel geometry, and an environmental exposure characteristic of the body panel;
comparing the panel material, the panel geometry, and the environmental exposure characteristic to a plurality of identification records;
identifying, based on the comparison, a sensor position change of one or more of the plurality of sensors on the body panel, wherein the sensor position change has resulted in an acoustic signature match rate that is greater than the acoustic signature match rate associated with the body panel; and
changing a location of the one or more sensors of the plurality of sensors on the body panel based on the identification record, wherein the changed location matches a sensor position of the body panel having the greater acoustic signature match.

7. The method of claim 1, further comprising outputting, via the processor, an output signal indicative of the panel breach and the location of the body panel breach, wherein the processor sends the output signal to at least one of a mobile device and a vehicle output interface.

8. A system for detecting and locating a body panel breach on a vehicle, the system comprising:
a processor operatively connected with a plurality of embedded sensors in the body panel of the vehicle, the processor configured to:
receive an acoustic feedback signal from the plurality of sensors; and
identify a panel breach and a location of the panel breach indicative of damage on the body panel, the identifying based on the acoustic feedback signal from the plurality of sensors.

9. The system of claim 8, wherein identifying the body panel breach comprises:
isolating, via the processor, an acoustic signature from the acoustic feedback signal;
comparing, via the processor, the acoustic signature to a plurality of acoustic signatures stored on an acoustic signature database; and
identifying, via the processor, a matching signature wherein the matching signature shares a predetermined number of identifying components with the acoustic signature.

10. The system of claim 9, wherein the processor is further configured to:
determine a location on the body panel having the body panel breach, wherein the panel breach alters the acoustic signature of the body panel.

11. The system of claim 8, wherein identifying the body panel breach and the location of the body panel breach comprises:
identifying an acoustic signature anomaly in the acoustic feedback signal;
determining whether the acoustic signature anomaly is dispositive of the body panel breach;
responsive to determining that the acoustic signature anomaly is not dispositive of the body panel breach, comparing the acoustic signature anomaly to one or more stored acoustic signature anomalies during a predetermined period of time; and
detecting, via the processor, a change in the acoustic signature anomaly that is indicative of the body panel breach.

12. The system of claim 11, wherein detecting the change in the acoustic signature anomaly comprises determining a propagation of the body panel breach after the predetermined period of time, wherein the propagation of the body panel breach is indicative of an increase in a dimension of the breach with respect to time, and indicative of a location of the increase in dimension of the body panel breach.

13. The system of claim 8, wherein the processor is further configured to:
store an identification record indicative of a body panel material, a body panel geometry, and an environmental exposure characteristic of the body panel;
compare the panel material, the panel geometry, and the environmental exposure characteristic to a plurality of identification records;
identify, based on the comparison, a sensor position change of one or more sensors of the plurality of sensors on the body panel, wherein the sensor position change has resulted in an acoustic signature match rate that is greater than the acoustic signature match rate associated with the body panel; and
change a location of one or more sensors of the plurality of sensors on the body panel based on the identification record, wherein the changed location matches a sensor position of the body panel having the greater acoustic signature match.

14. The system of claim 8, further comprising outputting, via the processor, an output signal indicative of the panel breach and the location of the body panel breach, wherein the processor sends the output signal to at least one of a mobile device and a vehicle output interface.

15. The system of claim 8, wherein the processor is configured to output a signal indicative of the panel breach and the location of the body panel breach, wherein the processor sends the output signal to at least one of a mobile device and a vehicle output interface.

16. A computer-readable storage medium storing executable instructions configured to, when executed by a processor, cause the processor to perform a method, the method comprising:
receiving, via the processor, an acoustic feedback signal from a plurality of sensors embedded in a body panel of a vehicle; and
identifying, via the processor, a body panel breach and a location of the body panel breach indicative of damage on the body panel, the identifying based on the acoustic feedback signal from the plurality of sensors.

17. The computer-readable storage medium of claim 16, wherein identifying the body panel breach comprises:
isolating, via the processor, an acoustic signature from the acoustic feedback signal;
comparing, via the processor, the acoustic signature to a plurality of acoustic signatures stored on an acoustic signature database; and
identifying, via the processor, a matching signature wherein the matching signature shares a predetermined number of identifying components with the acoustic signature.

18. The computer-readable storage medium of claim 17, wherein the processor is further configured to:
determining, via the processor, a location on the body panel having the body panel breach, wherein the panel breach alters the acoustic signature of the body panel.

19. The computer-readable storage medium of claim 16, wherein identifying the body panel breach and the location of the body panel breach comprises:
identifying an acoustic signature anomaly in the acoustic feedback signal;
determining whether the acoustic signature anomaly is dispositive of the body panel breach;
responsive to determining that the acoustic signature anomaly is not dispositive of the body panel breach, comparing the acoustic signature anomaly to one or more stored acoustic signature anomalies during a predetermined period of time; and
detecting, via the processor, a change in the acoustic signature anomaly that is indicative of the body panel breach.

20. The computer-readable storage medium of claim 19, wherein detecting the change in the acoustic signature anomaly comprises determining a propagation of the body panel breach after the predetermined period of time, wherein the propagation of the body panel breach is indicative of an increase in a dimension of the breach with respect to time, and indicative of a location of the increase in dimension of the body panel breach.
